(19) United States
(12) Patent Application Publication
(10) Pub. No.: US 2026/0259394 A1
(43) Pub. Date: Sep. 3, 2026

(54) OPTICAL IMAGING SYSTEM

(71) Applicant: SAMSUNG ELECTRO-MECHANICS CO., LTD., Suwon-si (KR)

(72) Inventors: Woo Young KIM, Suwon-si (KR); Tae Yeon LIM, Suwon-si (KR); Seong Il CHO, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 19/423,335

(22) Filed: Dec. 17, 2025

(30) Foreign Application Priority Data
Feb. 28, 2025 (KR) 10-2025-0026322

(51) Int. Cl. G02B 13/00; G02B 9/60

(52) U.S. Cl. CPC G02B 13/0065; G02B 9/60; G02B 13/0045

(57) ABSTRACT

An optical imaging system includes a first lens group, an optical path conversion member, and a second lens group, arranged sequentially from an object side, wherein the first lens group includes a plurality of lenses arranged along a first optical axis, and the second lens group includes a plurality of lenses arranged along a second optical axis, and wherein the optical imaging system satisfies conditional expression 1.5≤fG1/f≤3.0, where fG1 is a focal length of the first lens group and f is a focal length of the optical imaging system.

### CROSS-REFERENCE TO RELATED APPLICATIONS

This application claims the benefit under 35 USC 119(a) of Korean Patent Application No. 10-2025-0026322 filed on Feb. 28, 2025, in the Korean Intellectual Property Office, the entire disclosure of which is incorporated herein by reference for all purposes.

### BACKGROUND

### 1. Field

The present disclosure relates to an optical imaging system.

### 2. Description of the Background

Demand for telephoto camera modules capable of achieving high magnification has increased in the mobile camera market.

Consequently, camera modules having a structure of bending a path of light by disposing a reflective member, such as a prism, in front of a lens to increase the focal length without increasing a module size have been adopted.

Meanwhile, even the aforementioned structure still may have problems requiring improvement, such as low-light imaging performance, and the development of a telephoto camera to address the problems may be desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, an optical path conversion member, and a second lens group, arranged sequentially from an object side, wherein the first lens group includes a plurality of lenses arranged along a first optical axis, and the second lens group includes a plurality of lenses arranged along a second optical axis, and wherein the optical imaging system satisfies conditional expression 1.5≤fG1/f≤3.0 where fG1 is a focal length of the first lens group and f is a focal length of the optical imaging system.

The optical imaging system may satisfy conditional expression 1.0<fG1/fG2≤2.0, where fG2 is a focal length of the second lens group.

The optical imaging system may satisfy conditional expression 2≤h1/h2≤3, where h1 is a maximum height of the optical imaging system in a first optical axis direction and h2 is a maximum height of the second lens group in the first optical axis direction.

The optical imaging system may satisfy conditional expression 0.5≤h2/Fno≤2 (unit: mm), where h2 is a maximum height of the second lens group in a first optical axis direction and Fno is an F value of the optical imaging system.

The first lens group may include a first lens and a second lens arranged sequentially from the object side, and the first lens may have positive refractive power and the second lens may have negative refractive power.

The optical imaging system may satisfy conditional expression 0.5≤|f/f1|+|f/f2|≤2.0, where f1 is a focal length of the first lens and f2 is a focal length of the second lens.

An image-side surface of the first lens and an object-side surface of the second lens may each be concave.

The first lens group and the second lens group may each have positive refractive power, and a focal length of the second lens group may be shorter than a focal length of the first lens group.

The optical imaging system may include a first lens, a second lens, a third lens, a fourth lens, and a fifth lens arranged sequentially from the object side, and may satisfy conditional expression 0.3≤dG1G2/OAL≤0.5, where dG1G2 is a distance on an optical axis between the first lens group and the second lens group, OAL is a distance on the optical axis from an object-side surface of the first lens to an image plane, and the optical axis includes the first optical axis and the second optical axis.

The first lens may have positive refractive power, the second lens may have negative refractive power, the third lens may have positive refractive power, the fourth lens may have negative refractive power, and the fifth lens may have negative refractive power.

The first lens group may include the first lens and the second lens, and the second lens group may include the third lens, the fourth lens, and the fifth lens.

An object-side surface of the third lens may be convex, and an image-side surface of the third lens may be concave.

An object-side surface of the fourth lens may be convex.

An object-side surface of the fifth lens may be concave.

An image-side surface of the fifth lens may be convex.

The third lens may be a D-cut lens.

Other features and aspects will be apparent from the following detailed description, the drawings, and the claims.

### BRIEF DESCRIPTION OF DRAWINGS

FIG. 1A is a schematic diagram of an optical imaging system according to a first embodiment of the present disclosure.

FIG. 1B is a graph illustrating the aberration characteristics of the optical imaging system of FIG. 1A.

FIG. 2A is a schematic diagram of an optical imaging system according to a second embodiment of the present disclosure.

FIG. 2B is a graph illustrating the aberration characteristics of the optical imaging system of FIG. 2A.

FIG. 3A is a schematic diagram of an optical imaging system according to a third embodiment of the present disclosure.

FIG. 3B is a graph illustrating the aberration characteristics of the optical imaging system of FIG. 3A.

FIG. 4A is a schematic diagram of an optical imaging system according to a fourth embodiment of the present disclosure.

FIG. 4B is a graph illustrating the aberration characteristics of the optical imaging system of FIG. 4A.

FIG. 5A is a schematic diagram of an optical imaging system according to a fifth embodiment of the present disclosure.

FIG. 5B is a graph illustrating the aberration characteristics of the optical imaging system of FIG. 5A.

FIG. 6A is a schematic diagram of an optical imaging system according to a sixth embodiment of the present disclosure.

FIG. 6B is a graph illustrating the aberration characteristics of the optical imaging system of FIG. 6A.

FIG. 7A is a schematic diagram of an optical imaging system according to a seventh embodiment of the present disclosure.

FIG. 7B is a graph illustrating the aberration characteristics of the optical imaging system of FIG. 7A.

FIG. 8A is a schematic diagram of an optical imaging system according to an eighth embodiment of the present disclosure.

FIG. 8B is a graph illustrating the aberration characteristics of the optical imaging system of FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the accompanying diagrams, the thicknesses, sizes, and shapes of lenses may be somewhat exaggerated for illustrative purposes. The spherical or aspherical shape of the lenses may also be provided as examples and the embodiments of the disclosure are not intended to be limited to the shapes shown in the drawings.

The optical imaging system according to embodiments of the present disclosure may be mounted on a portable electronic device. For example, the optical imaging system may form a portion of a camera module mounted on a portable electronic device, and the portable electronic device may be a smartphone, tablet PC, or the like.

In this specification, a first lens (or the frontmost lens) refers to a lens closest to an object side, and the last lens (or the rearmost lens) refers to a lens closest to an imaging plane of an image sensor. Here, the imaging plane refers to a virtual plane in which the optical imaging system focuses or one surface of an image sensor in which light is received.

Also, in the description of each lens, a first surface refers to a surface closer to the object side (or an object-side surface), and a second surface refers to a surface closer to an image side (or an image-side surface).

In addition, in the description of the shape of each lens, a convex shape on one surface means that the corresponding surface is convex in a paraxial region (a very narrow region near and including the optical axis), and a concave shape on one surface means that the corresponding surface is concave in the paraxial region.

In addition, in this specification, numerical values, such as the radius of curvature, thickness, distance, and focal length of a lens are all expressed in millimeters (mm), and the field of view (FOV) is expressed in degrees (°).

An aspect of the present disclosure is to provide an optical imaging system having improved imaging performance, such as image quality and brightness.

An optical imaging system according to embodiments of the present disclosure includes a plurality of lens groups. For example, the optical imaging system may include a first lens group and a second lens group.

In embodiments, the first lens group and the second lens group may each include one or more lenses. For example, the first lens group may include two lenses, and the second lens group may include three lenses. Therefore, the optical imaging system may include five lenses.

In embodiments, the optical imaging system may include a first lens, a second lens, a third lens, a fourth lens, and a fifth lens, arranged sequentially from the object side. Each lens may be spaced apart from one another by a predetermined distance.

The optical imaging system according to embodiments of the present disclosure may include a lens formed of plastic. For example, the first through fifth lenses may all be formed of plastic.

The optical imaging system according to embodiments of the present disclosure may include a lens having at least one aspherical surface. For example, at least one of the first through fifth lenses may have at least one aspherical surface among the first and second surfaces. The aspherical surface of the lens is expressed by Mathematical Formula 1.

$$Z = \frac{c {Y}^{2}}{1 + \sqrt{1 - ( 1 + K ) {c}^{2} {Y}^{2}}} + A {Y}^{4} + B {Y}^{6} + {CY}^{8} + D {Y}^{10} + E {Y}^{12} + F {Y}^{14} + G {Y}^{16} + H {Y}^{18} + J {Y}^{20} + {LY}^{22} + M {Y}^{24} + N {Y}^{26} + {OY}^{28} + P {Y}^{30} \qquad Mathematical Formula 1$$

In Mathematical Formula 1, c is the reciprocal of the radius of curvature of the lens, K is the conic constant, and Y represents the distance from any point on the aspherical surface of the lens to the optical axis. In addition, constants A through H, J, and L through P are aspherical constants from the 4th to the 30th order, respectively, and Z (or SAG) represents the distance in the optical axis between any point on the aspherical surface and the vertex of the corresponding aspherical surface.

The optical imaging system according to embodiments of the present disclosure may include an optical path conversion member converting an optical path. For example, the optical path conversion member may be a member having a reflective surface, such as a mirror or a prism.

In embodiments, the optical path conversion member may be disposed between the first lens group and the second lens group. Accordingly, the optical axes of the first lens group and the second lens group may be different. For example, the lenses of the first lens group may be disposed along a first optical axis, the lenses of the second lens group may be disposed along a second optical axis, and the first and second optical axes may be approximately perpendicular to each other.

According to embodiments, by bending the optical path through the optical path conversion member, a relatively long optical path may be formed within a limited space. Therefore, the optical imaging system may be manufactured to be compact, while having a long focal length.

The optical imaging system according to embodiments of the present disclosure may further include an image sensor converting light reflected from a subject into an electrical signal.

In addition, the optical imaging system may further include an infrared cut filter (hereinafter, “filter”) for blocking infrared light incident on the image sensor. The filter may be disposed between the fifth lens and the image sensor.

In addition, the optical imaging system may further include a stop for controlling the amount of light. For example, the stop may be disposed between the fourth lens and the fifth lens.

The optical imaging system according to embodiments of the present disclosure may satisfy any one or any two or more of the conditional expressions below:

$$0.5 \leq \vert f / f 1 \vert + \vert f / f 2 \vert \leq 2. . \qquad Conditional Expression 1$$

$$1.5 \leq fG 1 / f \leq 3. . \qquad Conditional Expression 2$$

$$1. 0 < fG 1 / fG 2 \leq 2. . \qquad Conditional Expression 3$$

$$2 \leq h 1 / h 2 \leq 3. \qquad Conditional Expression 4$$

$$0.3 \leq dG 1 G 2 / OAL \leq 0.5 . \qquad Conditional Expression 5$$

$$0.5 \leq h 2 / Fno \leq 2 ( Unit : mm ) . \qquad Conditional Expression 6$$

In the conditional expressions, f is a total focal length of the optical imaging system, f1 is a focal length of the first lens, f2 is a focal length of the second lens, fG1 is a focal length of the first lens group, fG2 is a focal length of the second lens group, h1 is the maximum height of the optical imaging system along the first optical axis, h2 is the maximum height of the second lens group along the first optical axis, dG1G2 is a distance on the optical axis between the first lens group and the second lens group, OAL is a distance on the optical axis from an object side surface of the first lens to an image plane, and Fno is the F-number of the optical imaging system.

In the conditional expressions, Conditional Expression 1 represents the focal length condition of the first lens group, i.e., the first and second lenses, for reducing aberrations. Conditional Expressions 2 and Conditional Expressions 3 represent the focal length conditions of the first and second lens groups for reducing the size of the second lens group. Conditional Expression 4 relates to the design feature of a relatively low module (e.g., camera) height relative to the optical performance of the optical imaging system. Conditional Expression 5 represents the arrangement condition of the first and second lens groups for reducing the module (e.g., camera) height. Conditional Expression 6 represents the brightness performance relative to the size of the optical imaging system.

According to embodiments of the present disclosure, the first lens group may include two lenses, for example, a first lens and a second lens. For example, the first lens may have positive refractive power, and the second lens may have negative refractive power. The first lens group as a whole may have positive refractive power. Accordingly, light passing through the first lens group may be refracted to converge and enter the optical path conversion member.

According to embodiments of the present disclosure, the second lens group may include three lenses, for example, a third lens, a fourth lens, and a fifth lens. For example, the third lens may have positive refractive power, and the fourth and fifth lenses may each have negative refractive power. The second lens group as a whole may have positive refractive power.

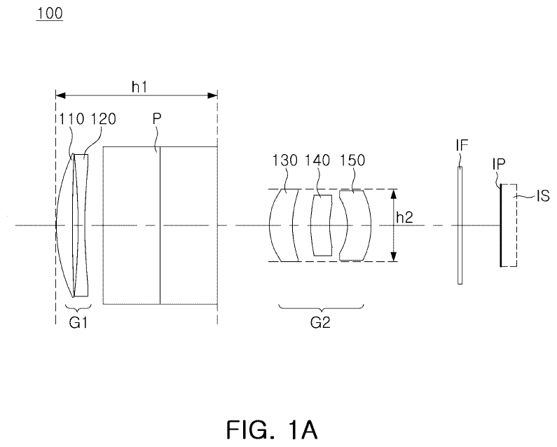

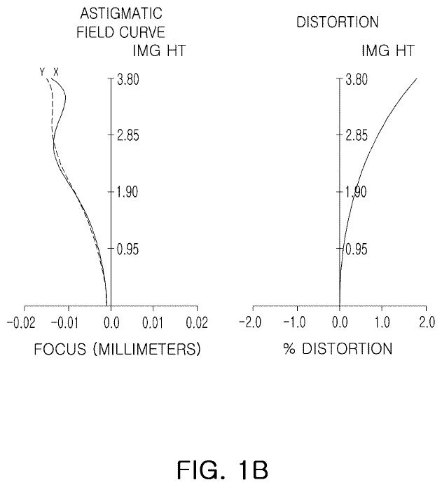

FIG. 1A is a schematic diagram of an optical imaging system according to a first embodiment of the present disclosure, and FIG. 1B is a graph illustrating aberration characteristics of the optical imaging system of FIG. 1A.

An optical imaging system 100 according to the first embodiment of the present disclosure may include a first lens group G1, an optical path conversion member P, and a second lens group G2, arranged sequentially from the object side.

The first lens group G1 may include a first lens 110 and a second lens 120, arranged sequentially from the object side. The second lens group G2 may include a third lens 130, a fourth lens 140, and a fifth lens 150, arranged sequentially from the object side.

The maximum height of the second lens group along the first optical axis h2 is shown for a circular lens having the maximum height of the second lens group G2 for illustrative purposes and is not intended to be limited thereby. For example, h2 may be less than that shown in FIG. 1A for a D-cut lens having a minor axis as the maximum height of the second lens group G2 along the first optical axis.

Also, the optical imaging system 100 may further include a filter IF and an image sensor IS having an imaging plane IP.

The optical path conversion member P may be arranged between the first lens group G1 and the second lens group G2, for example, between the second lens 120 and the third lens 130. For example, the optical path conversion member P may be provided as a prism including a reflective surface.

The physical and optical characteristics of the optical elements constituting the optical imaging system 100 according to the first embodiment of the present disclosure are shown in Table 1 below.

TABLE 1

| | | | | | | Effective | Effective |
|---|---|---|---|---|---|---|---|
| Surface | | Curvature | Thickness/ | Refractive | Abbe | Radius of | Radius of |
| No. | component | Radius | Distance | Index | Number | major axis | minor axis |
| Object | | Infinity | Infinity | | | | |
| S1 | | Infinity | 0.000 | | | | |
| S2 | First lens | 8.238 | 0.911 | 1.535 | 55.74 | 4.000 | 4.000 |
| S3 | | 34.459 | 0.291 | | | 3.976 | 3.976 |
| S4 | Second lens | −49.995 | 0.400 | 1.614 | 25.94 | 3.979 | 3.979 |
| S5 | | 35.694 | 1.020 | | | 3.886 | 3.886 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 2.900 | | | 4.000 | 2.900 |
| S9 | Third lens | 3.458 | 1.300 | 1.535 | 55.74 | 2.300 | 2.000 |
| S10 | | 7.426 | 0.996 | | | 2.421 | 2.000 |
| S11 | Fourth lens | 11.625 | 1.000 | 1.614 | 25.94 | 1.724 | 1.724 |
| S12 | (Stop) | 7.702 | 1.000 | | | 1.422 | 1.422 |
| S13 | Fifth lens | −3.105 | 1.300 | 1.661 | 20.38 | 1.557 | 1.557 |
| S14 | | −4.830 | 4.761 | | | 1.966 | 1.966 |
| S15 | Filter | Infinity | 0.210 | 1.517 | 62.00 | | |
| S16 | | Infinity | 2.161 | | | | |
| S17 | Imaging | Infinity | | | | | |
| | plane | | | | | | |

In the first embodiment of the present disclosure, the first lens 110 may have positive refractive power, a first surface of the first lens 110 may be convex, and a second surface of the first lens 110 may be concave. The second lens 120 may have negative refractive power, and both a first surface of the second lens 120 and a second surface of the second lens 120 may be concave. The third lens 130 may have positive refractive power, a first surface of the third lens 130 may be convex, and a second surface of the third lens 130 may be concave. The fourth lens 140 may have negative refractive power, a first surface of the fourth lens 140 may be convex, and a second surface of the fourth lens 140 may be concave. The fifth lens 150 may have negative refractive power, a first surface of the fifth lens 150 may be concave, and a second surface of the fifth lens 150 may be convex.

According to the first embodiment of the present disclosure, the second lens group G2 may include a D-cut lens. For example, the third lens 130 may be provided as a D-cut lens. A D-cut lens is a lens with a portion of an edge thereof cut off, including a pair of arc portions and a straight portion connecting the pair of arc portions. The D-cut lens has a major axis and a minor axis, and an effective radius of the major axis refers to a straight-line distance from the center of the lens to the arc portion, and an effective radius of the minor axis refers to a straight-line distance from the center of the lens to the straight portion.

Aspheric data for the individual lenses constituting the optical imaging system 100 according to the first embodiment of the present disclosure are as shown in Table 2 below. According to the first embodiment, the first and second surfaces of the first lens 110 to the fifth lens 150 may all be aspherical.

TABLE 2

| Surface No. | S2 | S3 | S4 | S5 | S9 |
|---|---|---|---|---|---|
| K | −0.8846 | −94.7570 | 84.6249 | −29.8650 | −0.0020 |
| A | −2.056E−04 | −1.156E−04 | −8.563E−07 | −1.813E−04 | 4.379E−04 |
| B | −6.733E−06 | −9.256E−06 | −1.057E−06 | −7.773E−06 | 3.009E−05 |
| C | −4.181E−07 | −2.749E−07 | −2.721E−07 | −1.182E−07 | 2.354E−06 |
| D | −1.081E−08 | −1.886E−08 | −6.774E−09 | −4.366E−10 | 9.525E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface No. | S10 | S11 | S12 | S13 | S14 |
| K | 0.0371 | 24.0051 | 0.1448 | 0.0441 | −7.6971 |
| A | 1.805E−01 | 2.749E−03 | 3.267E−02 | −2.847E−04 | −1.285E−01 |
| B | −2.860E−01 | −1.083E−03 | −9.210E−03 | −8.063E−05 | 6.044E−02 |
| C | 9.904E−02 | 1.493E−05 | 2.402E−02 | 8.759E−06 | −3.461E−02 |
| D | −9.338E−01 | −1.955E−05 | −5.468E−02 | −1.526E−05 | 7.246E−03 |
| E | 3.102E+00 | 0.000E+00 | 7.725E−02 | 0.000E+00 | 2.631E−02 |
| F | −6.351E+00 | 0.000E+00 | −6.670E−02 | 0.000E+00 | −4.990E−02 |
| G | 5.881E+00 | 0.000E+00 | 3.357E−02 | 0.000E+00 | 4.426E−02 |
| H | −1.226E+00 | 0.000E+00 | −8.826E−03 | 0.000E+00 | −2.006E−02 |
| J | −6.029E−01 | 0.000E+00 | 9.122E−04 | 0.000E+00 | 3.657E−03 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

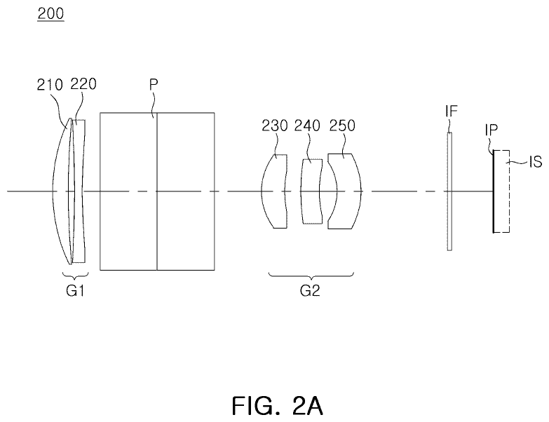

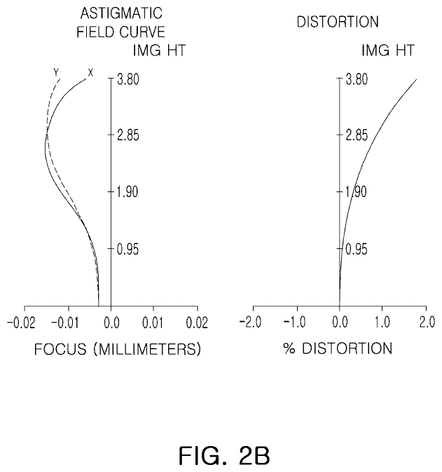

FIG. 2A is a schematic diagram of an optical imaging system according to a second embodiment of the present disclosure, and FIG. 2B is a graph illustrating the aberration characteristics of the optical imaging system of FIG. 2A.

An optical imaging system 200 according to the second embodiment of the present disclosure may include a first lens group G1, an optical path conversion member P, and a second lens group G2, arranged sequentially from the object side.

The first lens group G may include a first lens 210 and a second lens 220, arranged sequentially from the object side. The second lens group G2 may include a third lens 230, a fourth lens 240, and a fifth lens 250, arranged sequentially from the object side.

Also, the optical imaging system 200 may further include a filter IF and an image sensor IS having an imaging plane aP.

The optical path conversion member P may be disposed between the first lens group G and the second lens group G2, for example, between the second lens 220 and the third lens 230. For example, the optical path conversion member P may be configured as a prism including a reflective surface.

The physical and optical characteristics of the optical elements constituting the optical imaging system 200 according to the second embodiment of the present disclosure are shown in Table 3 below.

TABLE 3

| | | | | | | Effective | Effective |
|---|---|---|---|---|---|---|---|
| Surface | | Curvature | Thickness/ | Refractive | Abbe | Radius of | Radius of |
| No. | Component | Radius | Distance | Index | Number | major axis | minor axis |
| Object | | Infinity | Infinity | | | | |
| S1 | | Infinity | 0.000 | | | | |
| S2 | First lens | 8.049 | 0.910 | 1.535 | 55.74 | 4.000 | 4.000 |
| S3 | | 30.150 | 0.291 | | | 3.974 | 3.974 |
| S4 | Second lens | −38.257 | 0.400 | 1.614 | 25.94 | 3.975 | 3.975 |
| S5 | | 51.400 | 1.020 | | | 3.864 | 3.864 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 2.651 | | | 4.000 | 2.900 |
| S9 | Third lens | 3.420 | 1.300 | 1.535 | 55.74 | 2.300 | 2.000 |
| S10 | | 7.450 | 0.867 | | | 2.421 | 2.000 |
| S11 | Fourth lens | 11.466 | 1.000 | 1.614 | 25.94 | 1.753 | 1.753 |
| S12 | (Stop) | 7.021 | 1.000 | | | 1.435 | 1.435 |
| S13 | Fifth lens | −3.125 | 1.300 | 1.661 | 20.38 | 1.630 | 1.630 |
| S14 | | −4.756 | 4.761 | | | 2.000 | 2.000 |
| S15 | Filter | Infinity | 0.210 | 1.517 | 62.00 | | |
| S16 | | Infinity | 2.329 | | | | |
| S17 | Imaging | Infinity | | | | | |
| | plane | | | | | | |

In the second embodiment of the present disclosure, the first lens 210 may have positive refractive power, a first surface of the first lens 210 may be convex, and a second surface of the first lens 210 may be concave. The second lens 220 may have negative refractive power, and both a first surface of the second lens 220 and a second surface of the second lens 220 may be concave. The third lens 230 may have positive refractive power, a first surface of the third lens 230 may be convex, and a second surface of the third lens 230 may be concave. The fourth lens 240 may have negative refractive power, a first surface of the fourth lens 240 may be convex, and a second surface of the fourth lens 240 may be concave. The fifth lens 250 may have negative refractive power, a first surface of the fifth lens 250 may be concave, and a second surface of the fifth lens 250 may be convex.

According to the second embodiment of the present disclosure, the second lens group G2 may include a D-cut lens. For example, the third lens 230 may be provided as a D-cut lens.

Aspheric data for the individual lenses constituting the optical imaging system 200 according to the second embodiment of the present disclosure are shown in Table 4 below. According to the second embodiment, the first and second surfaces of the first lens 210 to the fifth lens 250 may all be aspherical.

TABLE 4

| Surface No. | S2 | S3 | S4 | S5 | S9 |
|---|---|---|---|---|---|
| K | −0.7800 | −64.8572 | −24.0541 | 94.1354 | −0.0124 |
| A | −1.805E−04 | −9.537E−05 | 1.561E−04 | −2.095E−05 | 2.701E−04 |
| B | −5.548E−06 | −8.419E−06 | 3.340E−06 | 5.197E−07 | 2.143E−05 |
| C | −5.189E−07 | −2.899E−07 | −1.092E−07 | −1.624E−08 | 6.218E−06 |
| D | −1.263E−08 | −1.652E−08 | −2.011E−08 | −2. 134E−08 | 1.242E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E2+00 | 0.000E+00 | 0.000E+00 |
| Surface No. | S10 | S11 | S12 | S13 | S14 |
| K | 0.0371 | 22.7439 | 0.1448 | 0.2915 | −6.8696 |
| A | 1.168E−01 | 2.565E−03 | 3.235E−02 | −2.402E−03 | −1.608E−01 |
| B | −2.586E−01 | −1.206E−03 | −1.834E−02 | −1.481E−04 | 5.631E−02 |
| C | −1.951E+00 | 1.607E−05 | 7.119E−02 | 1.796E−05 | 9.814E−03 |
| D | 1.774E+01 | −1.544E−05 | −2.142E−01 | −1.090E−05 | −1.336E−01 |
| E | −9.469E+01 | 0.000E+00 | 3.986E−01 | 0.000E+00 | 3.121E−01 |
| F | 3.129E+02 | 0.000E+00 | −4.618E−01 | 0.000E+00 | −4.095E−01 |
| G | −6.275E+02 | 0.000E+00 | 3.242E−01 | 0.000E+00 | 3.175E−01 |
| H | 6.955E+02 | 0.000E+00 | −1.262E−01 | 0.000E+00 | −1.338E−01 |
| J | −3.261E+02 | 0.000E+00 | 2.090E−02 | 0.000E+00 | 2.336E−02 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

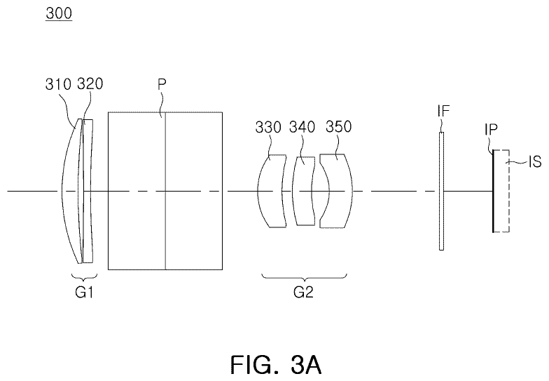

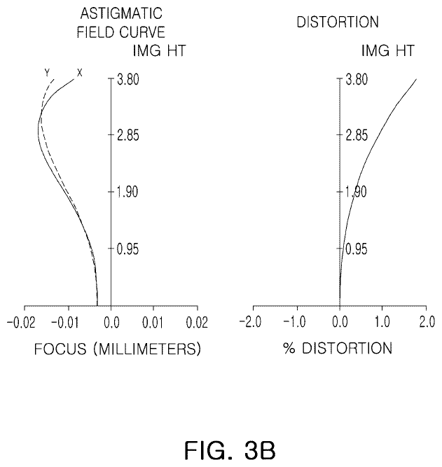

FIG. 3A is a schematic diagram of an optical imaging system according to a third embodiment of the present disclosure, and FIG. 3B is a graph illustrating the aberration characteristics of the optical imaging system of FIG. 3A.

An optical imaging system 300 according to the third embodiment of the present disclosure may include a first lens group G1, an optical path conversion member P, and a second lens group G2, arranged sequentially from the object side.

The first lens group G1 may include a first lens 310 and a second lens 320, arranged sequentially from the object side. The second lens group G2 may include a third lens 330, a fourth lens 340, and a fifth lens 350, arranged sequentially from the object side.

In addition, the optical imaging system 300 may further include a filter IF and an image sensor IS having an imaging plane IP.

The optical path conversion member P may be disposed between the first lens group G1 and the second lens group G2, for example, between the second lens 320 and the third lens 330. For example, the optical path conversion member P may be configured as a prism including a reflective surface.

The physical and optical characteristics of the optical elements constituting the optical imaging system 300 according to the third embodiment of the present disclosure are shown in Table 5 below.

TABLE 5

| | | | | | | Effective | Effective |
|---|---|---|---|---|---|---|---|
| Surface | | Curvature | Thickness/ | Refractive | Abbe | Radius of | Radius of |
| No. | Component | Radius | Distance | Index | Number | major axis | minor axis |
| Object | | Infinity | Infinity | | | | |
| S1 | | Infinity | 0.000 | | | | |
| S2 | First lens | 7.895 | 0.914 | 1.535 | 55.74 | 4.000 | 4.000 |
| S3 | | 20.474 | 0.287 | | | 3.953 | 3.953 |
| S4 | Second lens | −78.912 | 0.400 | 1.650 | 21.54 | 3.955 | 3.955 |
| S5 | | 58.765 | 1.020 | | | 3.854 | 3.854 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 1.971 | | | 4.000 | 2.900 |
| S9 | Third lens | 3.420 | 1.300 | 1.535 | 55.74 | 2.300 | 2.000 |
| S10 | | 7.200 | 0.654 | | | 2.421 | 2.000 |
| S11 | Fourth lens | 10.860 | 1.000 | 1.614 | 25.94 | 1.821 | 1.821 |
| S12 | (Stop) | 7.133 | 1.000 | | | 1.484 | 1.484 |
| S13 | Fifth lens | −2.997 | 1.300 | 1.661 | 20.38 | 1.609 | 1.609 |
| S14 | | −4.584 | 4.761 | | | 2.000 | 2.000 |
| S15 | Filter | Infinity | 0.210 | 1.517 | 62.00 | | |
| S16 | | Infinity | 2.774 | | | | |
| S17 | Imaging | Infinity | | | | | |
| | plane | | | | | | |

In the third embodiment of the present disclosure, the first lens 310 may have positive refractive power, a first surface of the first lens 310 may be convex, and a second surface of the first lens 310 may be concave. The second lens 320 may have negative refractive power, and both a first surface of the second lens 320 and a second surface of the second lens 320 may be concave. The third lens 330 may have positive refractive power, a first surface of the third lens 330 may be convex, and a second surface of the third lens 330 may be concave. The fourth lens 340 may have negative refractive power, a first surface of the fourth lens 340 may be convex, and a second surface of the fourth lens 340 may be concave. The fifth lens 350 may have negative refractive power, a first surface of the fifth lens 350 may be concave, and a second surface of the fifth lens 350 may be convex.

According to the third embodiment of the present disclosure, the second lens group G2 may include a D-cut lens. For example, the third lens 330 may be provided as a D-cut lens.

Aspheric data for the individual lenses constituting the optical imaging system 300 according to the third embodiment of the present disclosure are shown in Table 6 below. According to the third embodiment, the first and second surfaces of the first lens 310 to the fifth lens 350 may all be aspherical.

TABLE 6

| Component | S2 | S3 | S4 | S5 | S9 |
|---|---|---|---|---|---|
| K | −0.9437 | −30.1969 | 34.5422 | 99.0000 | 0.0133 |
| )A | −2.232E−04 | −8.720E−05 | 1.375E−04 | −1.192E−05 | 4.724E−04 |
| B | −5.444E−06 | −1.067E−05 | 3.737E−06 | 7.970E−07 | 2.639E−05 |
| C | −5.764E−07 | −3.224E−07 | −6.447E−08 | 9.443E−08 | 1.270E−05 |
| D | −7.052E−09 | −1.216E−08 | −1.681E−08 | −1.577E−08 | 8.018E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Component | S10 | S11 | S12 | S13 | S14 |
| K | 0.0371 | 22.4768 | 0.1448 | 0.3482 | −6.4853 |
| A | 1.416E−01 | 2.271E−03 | 3.312E−02 | −2.753E−03 | −1.605E−01 |
| B | −4.318E−01 | −1.244E−03 | −2.286E−02 | −3.774E−04 | 5.129E−02 |
| )C | −1.409E+00 | 5.425E−06 | 1.006E−01 | −3.172E−05 | 1.839E−02 |
| D | 1.331E+01 | −1.048E−05 | −3.409E−01 | −9.915E−06 | −1.807E−01 |
| E | −6.842E+01 | 0.000E+00 | 7.072E−01 | 0.000E+00 | 4.528E−01 |
| F | 2.076E+02 | 0.000E+00 | −9.044E−01 | 0.000E+00 | −6.462E−01 |
| G | −3.692E+02 | 0.000E+00 | 6.966E−01 | 0.000E+00 | 5.490E−01 |
| H | 3.485E+02 | 0.000E+00 | −2.959E−01 | 0.000E+00 | −2.563E−01 |
| J | −1.293E+02 | 0.000E+00 | 5.332E−02 | 0.000E+00 | 5.041E−02 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

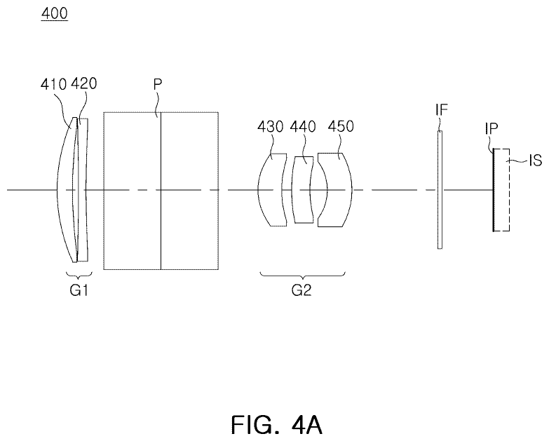

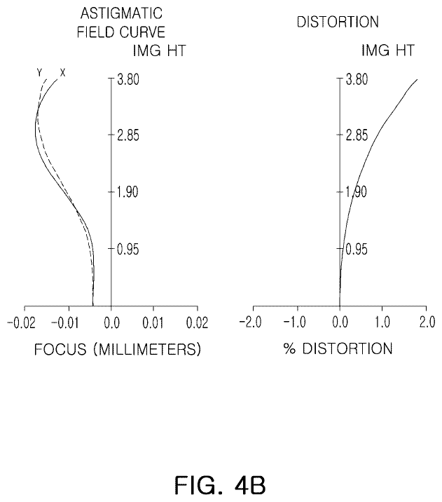

FIG. 4A is a schematic diagram of an optical imaging system according to a fourth embodiment of the present disclosure, and FIG. 4B is a graph illustrating the aberration characteristics of the optical imaging system of FIG. 4A.

An optical imaging system 400 according to the fourth embodiment of the present disclosure may include a first lens group G1, an optical path conversion member P, and a second lens group G2, arranged sequentially from the object side.

The first lens group G1 may include a first lens 410 and a second lens 420, arranged sequentially from the object side. The second lens group G2 may include a third lens 430, a fourth lens 440, and a fifth lens 450, arranged sequentially from the object side.

In addition, the optical imaging system 400 may further include a filter IF and an image sensor IS having an imaging plane IP.

The optical path conversion member P may be disposed between the first lens group G1 and the second lens group G2, for example, between the second lens 420 and the third lens 430. For example, the optical path conversion member P may be configured as a prism including a reflective surface.

The physical and optical characteristics of the optical elements constituting the optical imaging system 400 according to the fourth embodiment of the present disclosure are as shown in Table 7 below.

TABLE 7

| | | | | | | Effective | Effective |
|---|---|---|---|---|---|---|---|
| Surface | | Curvature | Thickness/ | Refractive | Abbe | Radius of | Radius of |
| No. | Component | Radius | Distance | Index | Number | major axis | minor axis |
| Object | | Infinity | Infinity | | | | |
| S1 | | Infinity | 0.000 | | | | |
| S2 | First lens | 7.746 | 0.885 | 1.535 | 55.74 | 4.000 | 4.000 |
| S3 | | 18.918 | 0.317 | | | 3.959 | 3.959 |
| S4 | Second lens | −91.858 | 0.400 | 1.650 | 21.54 | 3.958 | 3.958 |
| S5 | | 63.347 | 1.020 | | | 3.868 | 3.868 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 2.266 | | | 4.000 | 2.900 |
| S9 | Third lens | 3.412 | 1.300 | 1.535 | 55.74 | 2.300 | 2.000 |
| S10 | | 7.057 | 0.543 | | | 2.421 | 2.000 |
| S11 | Fourth lens | 10.513 | 1.000 | 1.650 | 21.54 | 1.862 | 1.862 |
| S12 | (Stop) | 6.931 | 1.000 | | | 1.514 | 1.514 |
| S13 | Fifth lens | −2.945 | 1.300 | 1.661 | 20.38 | 1.634 | 1.634 |
| S14 | | −4.378 | 4.761 | | | 2.000 | 2.000 |
| S15 | Filter | Infinity | 0.210 | 1.517 | 62.00 | | |
| S16 | | Infinity | 2.805 | | | | |
| S17 | Imaging | Infinity | | | | | |
| | plane | | | | | | |

In the fourth embodiment of the present disclosure, the first lens 410 may have positive refractive power, a first surface of the first lens 410 may be convex, and a second surface of the first lens 410 may be concave. The second lens 420 may have negative refractive power, and both a first surface of the second lens 420 and a second surface of the second lens 420 may be concave. The third lens 430 may have positive refractive power, a first surface of the third lens 430 may be convex, and a second surface of the third lens 430 may be concave. The fourth lens 440 may have negative refractive power, a first surface of the fourth lens 440 may be convex, and a second surface of the fourth lens 440 may be concave. The fifth lens 450 may have negative refractive power, a first surface of the fifth lens 450 may be concave, and a second surface of the fifth lens 450 may be convex.

According to the fourth embodiment of the present disclosure, the second lens group G2 may include a D-cut lens. For example, the third lens 430 may be provided as a D-cut lens.

Aspheric data for the individual lenses constituting the optical imaging system 400 according to the fourth embodiment of the present disclosure are shown in Table 8 below. According to the fourth embodiment, the first and second surfaces of the first lens 410 to the fifth lens 450 may all be aspherical.

TABLE 8

| Surface No. | S2 | S3 | S4 | S5 | S9 |
|---|---|---|---|---|---|
| K | −0.9393 | −24.4177 | 86.2845 | 99.0000 | −0.0039 |
| A | −2.221E−04 | −9.030E−05 | 1.263E−04 | −8.472E−06 | 3.967E−04 |
| B | −5.616E−06 | −1.156E−05 | 3.474E−06 | 9.876E−07 | −4.861E−06 |
| C | −6.030E−07 | −3.238E−07 | −4.941E−08 | 9.714E−08 | 1.728E−05 |
| D | −5.415E−09 | −7.046E−09 | −1.598E−08 | −1.790E−08 | −4.749E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| )G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface No. | S10 | S11 | S12 | S13 | S14 |
| K | 0.0371 | 22.1429 | 0.1448 | 0.4490 | −5.9701 |
| A | 1.611E−01 | 2.312E−03 | 2.967E−02 | −3.933E−03 | −1.875E−01 |
| B | −7.073E−01 | −1.210E−03 | −2.223E−02 | −4.623E−04 | 5.497E−02 |
| C | 8.856E−01 | 1.519E−05 | 9.678E−02 | 1.010E−05 | 5.393E−02 |
| D | −8.962E+00 | −5.549E−06 | −3.417E−01 | −1.739E−05 | −3.275E−01 |
| E | 6.827E+01 | 0.000E+00 | 7.429E−01 | 0.000E+00 | 8.070E−01 |
| F | −3.153E+02 | 0.000E+00 | −9.956E−01 | 0.000E+00 | −1.162E+00 |
| G | 8.425E+02 | 0.000E+00 | 8.049E−01 | 0.000E+00 | 9.935E−01 |
| H | −1.199E+03 | 0.000E+00 | −3.598E−01 | 0.000E+00 | −4.619E−01 |
| J | 7.089E+02 | 0.000E+00 | 6.850E−02 | 0.000E+00 | 8.917E−02 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

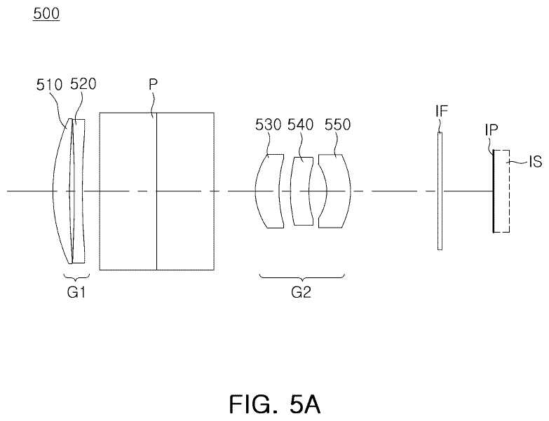

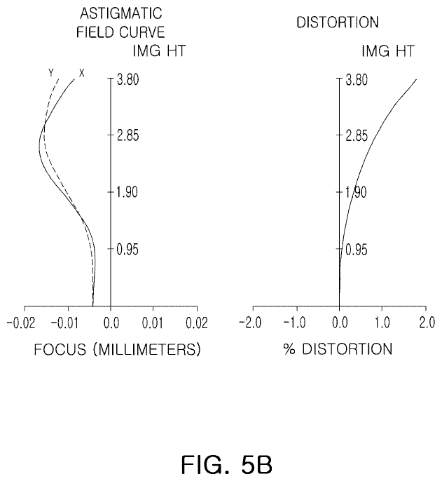

FIG. 5A is a schematic diagram of an optical imaging system according to a fifth embodiment of the present disclosure, and FIG. 5B is a graph illustrating the aberration characteristics of the optical imaging system of FIG. 5A.

An optical imaging system 500 according to the fifth embodiment of the present disclosure may include a first lens group G1, an optical path conversion member P, and a second lens group G2, arranged sequentially from the object side.

The first lens group G1 may include a first lens 510 and a second lens 520, arranged sequentially from the object side. The second lens group G2 may include a third lens 530, a fourth lens 540, and a fifth lens 550, arranged sequentially from the object side.

In addition, the optical imaging system 500 may further include a filter IF and an image sensor IS having an imaging plane IP.

The optical path conversion member P may be disposed between the first lens group G1 and the second lens group G2, for example, between the second lens 520 and the third lens 530. For example, the optical path conversion member P may be configured as a prism including a reflective surface.

The physical and optical characteristics of the optical elements constituting the optical imaging system 500 according to the fifth embodiment of the present disclosure are shown in Table 9 below.

TABLE 9

| | | | | | | Effective | Effective |
|---|---|---|---|---|---|---|---|
| Surface | | Curvature | Thickness/ | Refractive | Abbe | Radius of | Radius of |
| No. | Component | Radius | Distance | Index | Number | major axis | minor axis |
| Object | | Infinity | Infinity | | | | |
| S1 | | Infinity | 0.000 | | | | |
| S2 | First lens | 7.751 | 0.918 | 1.535 | 55.74 | 4.000 | 4.000 |
| S3 | | 22.493 | 0.283 | | | 3.966 | 3.966 |
| S4 | Second lens | −58.391 | 0.400 | 1.614 | 25.94 | 3.965 | 3.965 |
| S5 | | 45.823 | 1.020 | | | 3.859 | 3.859 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 2.317 | | | 4.000 | 2.900 |
| S9 | Third lens | 3.405 | 1.300 | 1.535 | 55.74 | 2.300 | 2.000 |
| S10 | | 7.252 | 0.676 | | | 2.421 | 2.000 |
| S11 | Fourth lens | 11.010 | 1.000 | 1.650 | 21.54 | 1.821 | 1.821 |
| S12 | (Stop) | 6.813 | 1.000 | | | 1.487 | 1.487 |
| S13 | Fifth lens | −2.966 | 1.300 | 1.661 | 20.38 | 1.562 | 1.562 |
| S14 | | −4.307 | 4.761 | | | 1.990 | 1.990 |
| S15 | Filter | Infinity | 0.210 | 1.517 | 62.00 | | |
| S16 | | Infinity | 2.814 | | | | |
| S17 | Imaging | Infinity | | | | | |
| | plane | | | | | | |

In the fifth embodiment of the present disclosure, the first lens 510 may have positive refractive power, a first surface of the first lens 510 may be convex, and a second surface of the first lens 510 may be concave. The second lens 520 may have negative refractive power, and both a first surface of the second lens 520 and a second surface of the second lens 520 may be concave. The third lens 530 may have positive refractive power, a first surface of the third lens 530 may be convex, and a second surface of the third lens 530 may be concave. The fourth lens 540 may have negative refractive power, a first surface of the fourth lens 540 may be convex, and a second surface of the fourth lens 540 may be concave. The fifth lens 550 may have negative refractive power, a first surface of the fifth lens 550 may be concave, and a second surface of the fifth lens 550 may be convex.

According to the fifth embodiment of the present disclosure, the second lens group G2 may include a D-cut lens. For example, the third lens 530 may be provided as a D-cut lens.

Aspheric data for the individual lenses constituting the optical imaging system 500 according to the fifth embodiment of the present disclosure is shown in Table 10 below. According to the fifth embodiment, the first and second surfaces of the first lens 510 to the fifth lens 550 may all be aspherical.

TABLE 10

| Component | S2 | S3 | S4 | S5 | S9 |
|---|---|---|---|---|---|
| K | −0.9109 | −36.7512 | 16.8631 | 74.1510 | −0.0234 |
| A | −2.134E−04 | −1.343E−04 | 1.702E−04 | −3.877E−05 | 2.617E−04 |
| B | −7.020E−06 | −1.191E−05 | 4.257E−06 | −3.141E−07 | −2.521E−05 |
| C | −6.729E−07 | −3.207E−07 | −1.161E−07 | 6.264E−08 | 1.288E−05 |
| D | −8.317E−09 | −1.172E−08 | −1.981E−08 | −2.526E−08 | −2.389E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Component | S10 | S11 | S12 | S13 | S14 |
| K | 0.0371 | 22.3601 | 0.0964 | 0.4401 | −5.8054 |
| A | 1.309E−01 | 2.158E−03 | 2.697E−02 | −4.030E−03 | −1.084E−02 |
| B | −6.554E−01 | −1.174E−03 | −1.755E−02 | −3.509E−04 | 7.439E−04 |
| C | 5.817E−01 | 2.896E−05 | 5.942E−02 | 1.909E−05 | 1.790E−04 |
| D | −4.190E+00 | −2.408E−06 | −1.730E−01 | −1.291E−05 | −2.384E−04 |
| E | 2.751E+01 | 0.000E+00 | 3.163E−01 | 0.000E+00 | 1.305E−04 |
| F | −1.074E+02 | 0.000E+00 | −3.579E−01 | 0.000E+00 | −4.177E−05 |
| G | 2.416E+02 | 0.000E+00 | 2.455E−01 | 0.000E+00 | 7.943E−06 |
| H | −2.888E+02 | 0.000E+00 | −9.351E−02 | 0.000E+00 | −8.237E−07 |
| J | 1.434E+02 | 0.000E+00 | 1.528E−02 | 0.000E+00 | 3.569E−08 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

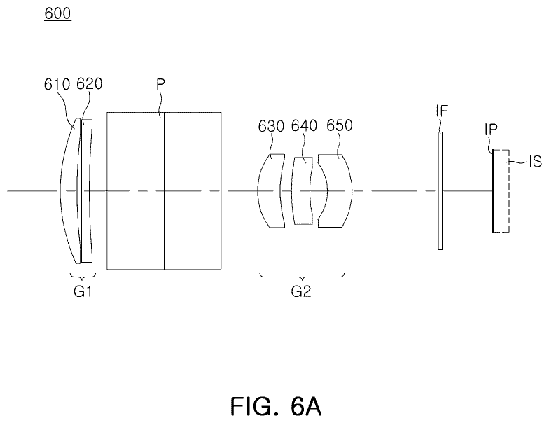

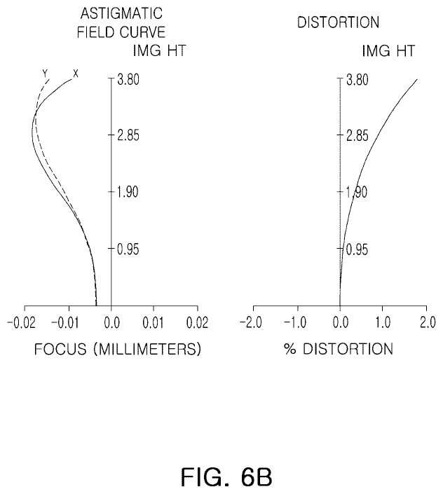

FIG. 6A is a schematic diagram of an optical imaging system according to a sixth embodiment of the present disclosure, and FIG. 6B is a graph illustrating the aberration characteristics of the optical imaging system of FIG. 6A.

An optical imaging system 600 according to the sixth embodiment of the present disclosure may include a first lens group G1, an optical path conversion member P, and a second lens group G2, arranged sequentially from the object side.

The first lens group G1 may include a first lens 610 and a second lens 620, arranged sequentially from the object side. The second lens group G2 may include a third lens 630, a fourth lens 640, and a fifth lens 650, arranged sequentially from the object side.

In addition, the optical imaging system 600 may further include a filter IF and an image sensor IS having an imaging plane IP.

The optical path conversion member P may be disposed between the first lens group G1 and the second lens group G2, for example, between the second lens 620 and the third lens 630. For example, the optical path conversion member P may be configured as a prism including a reflective surface.

The physical and optical characteristics of the optical elements constituting the optical imaging system 600 according to the sixth embodiment of the present disclosure are shown in Table 11 below.

TABLE 11

| | | | | | | Effective | Effective |
|---|---|---|---|---|---|---|---|
| Surface | | | Thickness/ | Refractive | Abbe | Radius of | Radius of |
| No. | Component | Curvature | Distance | Index | Number | major axis | minor axis |
| Object | | Infinity | Infinity | | | | |
| S1 | | Infinity | 0.000 | | | | |
| S2 | First lens | 7.800 | 0.894 | 1.535 | 55.74 | 4.000 | 4.000 |
| S3 | | 18.607 | 0.308 | | | 3.954 | 3.954 |
| S4 | Second lens | −181.181 | 0.400 | 1.661 | 20.38 | 3.937 | 3.937 |
| S5 | | 50.786 | 1.020 | | | 3.845 | 3.845 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 2.036 | | | 4.000 | 2.900 |
| S9 | Third lens | 3.406 | 1.239 | 1.535 | 55.74 | 2.300 | 2.000 |
| S10 | | 6.981 | 0.645 | | | 2.421 | 2.000 |
| S11 | Fourth lens | 10.389 | 1.000 | 1.650 | 21.54 | 1.846 | 1.846 |
| S12 | (Stop) | 7.113 | 1.000 | | | 1.503 | 1.503 |
| S13 | Fifth lens | −2.905 | 1.300 | 1.661 | 20.38 | 1.578 | 1.578 |
| S14 | | −4.372 | 4.761 | | | 2.000 | 2.000 |
| S15 | Filter | Infinity | 0.210 | 1.517 | 62.00 | | |
| S16 | | Infinity | 2.834 | | | | |
| S17 | Imaging | Infinity | | | | | |
| | plane | | | | | | |

In the sixth embodiment of the present disclosure, the first lens 610 may have positive refractive power, a first surface of the first lens 610 may be convex, and a second surface of the first lens 610 may be concave. The second lens 620 may have negative refractive power, and both a first surface of the second lens 620 and a second surface of the second lens 620 may be concave. The third lens 630 may have positive refractive power, a first surface of the third lens 630 may be convex, and a second surface of the third lens 630 may be concave. The fourth lens 640 may have negative refractive power, a first surface of the fourth lens 640 may be convex, and a second surface of the fourth lens 640 may be concave. The fifth lens 650 may have negative refractive power, a first surface of the fifth lens 650 may be concave, and a second surface of the fifth lens 650 may be convex.

According to the sixth embodiment of the present disclosure, the second lens group G2 may include a D-cut lens. For example, the third lens 630 may be provided as a D-cut lens.

Aspheric data for the individual lenses constituting the optical imaging system 600 according to the sixth embodiment of the present disclosure is shown in Table 12 below. According to the sixth embodiment, the first and second surfaces of the first lens 610 to the fifth lens 650 may all be aspherical.

TABLE 12

| Surface No. | S2 | S3 | S4 | S5 | S9 |
|---|---|---|---|---|---|
| K | −1.0479 | −24.5929 | 99.0000 | 90.3197 | −0.0024 |
| A | −2.498E−04 | −1.152E−04 | 1.455E−04 | −1.502E−05 | 4.213E−04 |
| )B | −7.126E−06 | −1.305E−05 | 4.066E−06 | 4.919E−07 | −1.044E−05 |
| C | −6.352E−07 | −3.618E−07 | −8.815E−08 | 1.095E−07 | 1.829E−05 |
| D | −4.266E−09 | −7.837E−09 | −1.874E−08 | −2.273E−08 | −9.644E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| )O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface No. | S10 | S11 | S12 | S13 | S14 |
| K | 0.0371 | 21.8615 | 0.1924 | 0.4340 | −5.9134 |
| A | 1.218E−01 | 2.038E−03 | 3.064E−02 | −3.738E−03 | −1.724E−01 |
| B | −4.323E−01 | −1.231E−03 | −2.840E−02 | −5.128E−04 | 5.401E−02 |
| C | −2.799E+00 | 7.444E−06 | 1.320E−01 | −2.041E−05 | −8.834E−03 |
| D | 2.575E+01 | −4.483E−06 | −4.821E−01 | −1.405E−05 | −4.461E−02 |
| E | 1.339E+02 | 0.000E+00 | 1.081E+00 | 0.000E+00 | 8.737E−02 |
| F | 4.163E+02 | 0.000E+00 | −1.497E+00 | 0.000E+00 | −5.292E−02 |
| G | −7.596E+02 | 0.000E+00 | 1.250E+00 | 0.000E+00 | −2.610E−02 |
| H | 7.451E+02 | 0.000E+00 | 5.760E−01 | 0.000E+00 | 5.053E−02 |
| J | −2.946E+02 | 0.000E+00 | 1.128E−01 | 0.000E+00 | −1.885E−02 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

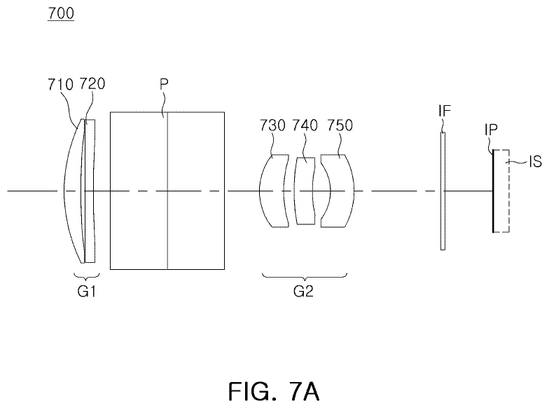

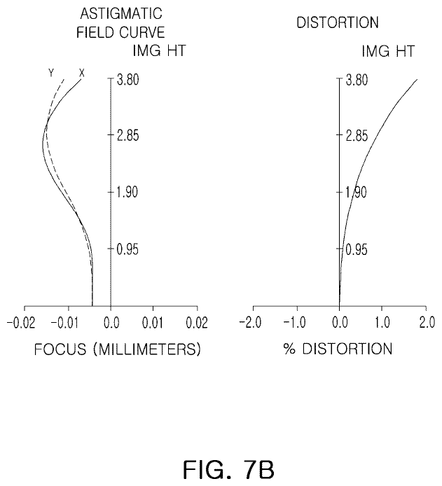

FIG. 7A is a schematic diagram of an optical imaging system according to a seventh embodiment of the present disclosure, and FIG. 7B is a graph illustrating the aberration characteristics of the optical imaging system of FIG. 7A.

An optical imaging system 700 according to the seventh embodiment of the present disclosure may include a first lens group G1, an optical path conversion member P, and a second lens group G2, arranged sequentially from the object side.

The first lens group G may include a first lens 710 and a second lens 720, arranged sequentially from the object side. The second lens group G2 may include a third lens 730, a fourth lens 740, and a fifth lens 750, arranged sequentially from the object side.

In addition, the optical imaging system 700 may further include a filter IF and an image sensor IS having an imaging plane mP.

The optical path conversion member P may be disposed between the first lens group G and the second lens group G2, for example, between the second lens 720 and the third lens 730. For example, the optical path conversion member P may be configured as a prism including a reflective surface.

The physical and optical characteristics of the optical elements constituting the optical imaging system 700 according to the seventh embodiment of the present disclosure are as shown in Table 13 below.

TABLE 13

| | | | | | | Effective | Effective |
|---|---|---|---|---|---|---|---|
| Surface | | | Thickness/ | Refractive | Abbe | Radius of | Radius of |
| No. | Component | Curvature | Distance | Index | Number | major axis | minor axis |
| Object | | Infinity | Infinity | | | | |
| S1 | | Infinity | 0.000 | | | | |
| S2 | First lens | 7.486 | 0.908 | 1.535 | 55.74 | 4.000 | 4.000 |
| S3 | | 17.555 | 0.293 | | | 3.958 | 3.958 |
| S4 | Second lens | −132.664 | 0.400 | 1.661 | 20.38 | 3.957 | 3.957 |
| S5 | | 54.336 | 1.020 | | | 3.865 | 3.865 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 1.999 | | | 4.000 | 2.900 |
| S9 | Third lens | 3.409 | 1.300 | 1.535 | 55.74 | 2.300 | 2.000 |
| S10 | | 7.156 | 0.569 | | | 2.421 | 2.000 |
| S11 | Fourth lens | 10.847 | 1.000 | 1.614 | 25.94 | 1.850 | 1.850 |
| S12 | (Stop) | 6.696 | 1.000 | | | 1.498 | 1.498 |
| S13 | Fifth lens | −3.041 | 1.300 | 1.661 | 20.38 | 1.568 | 1.568 |
| S14 | | −4.557 | 4.761 | | | 1.975 | 1.975 |
| S15 | Filter | Infinity | 0.210 | 1.517 | 62.00 | | |
| S16 | | Infinity | 2.689 | | | | |
| S17 | Imaging | Infinity | | | | | |
| | plane | | | | | | |

In the seventh embodiment of the present disclosure, the first lens 710 may have positive refractive power, a first surface of the first lens 710 may be convex, and a second surface of the first lens 710 may be concave. The second lens 720 may have negative refractive power, and both a first surface of the second lens 720 and a second surface of the second lens 720 may be concave. The third lens 730 may have positive refractive power, a first surface of the third lens 730 may be convex, and a second surface of the third lens 730 may be concave. The fourth lens 740 may have negative refractive power, a first surface of the fourth lens 740 may be convex, and a second surface of the fourth lens 740 may be concave. The fifth lens 750 may have negative refractive power, a first surface of the fifth lens 750 may be concave, and a second surface of the fifth lens 750 may be convex.

According to the seventh embodiment of the present disclosure, the second lens group G2 may include a D-cut lens. For example, the third lens 730 may be provided as a D-cut lens.

Aspheric data for the individual lenses constituting the optical imaging system 700 according to the seventh embodiment of the present disclosure is shown in Table 14 below. According to the seventh embodiment, the first and second surfaces of the first lens 710 to the fifth lens 750 may all be aspherical.

TABLE 14

| Component | S2 | S3 | S4 | S5 | S9 |
|---|---|---|---|---|---|
| K | −0.9739 | −21.2361 | 99.0000 | 93.7460 | −0.0121 |
| A | −2.301E−04 | −1.189E−04 | 1.278E−04 | −1.170E−05 | 3.496E−04 |
| B | −7.918E−06 | −1.428E−05 | 3.828E−06 | −2.134E−07 | −2.574E−05 |
| C | −7.174E−07 | −3.982E−07 | −8.778E−08 | 1.135E−07 | 1.728E−05 |
| D | −5.542E−09 | −7.171E−09 | −1.809E−08 | −2.185E−08 | −6.208E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Component | S10 | S11 | S12 | S13 | S14 |
| K | 0.0371 | 22.5319 | 0.2412 | 0.4762 | −6.1463 |
| A | 1.214E−01 | 1.897E−03 | 2.711E−02 | −4.590E−03 | −1.014E−02 |
| B | −8.002E−01 | −1.222E−03 | −2.223E−02 | −3.338E−04 | 6.992E−04 |
| C | 1.240E+00 | 1.590E−05 | 1.035E−01 | −3.042E−05 | 1.226E−04 |
| D | −8.899E+00 | −1.417E−06 | −3.495E−01 | −2.969E−06 | −1.916E−04 |
| E | 5.209E+01 | 0.000E+00 | 7.244E−01 | 0.000E+00 | 1.127E−04 |
| F | −1.977E+02 | 0.000E+00 | −9.213E−01 | 0.000E+00 | −3.850E−05 |
| G | 4.543E+02 | 0.000E+00 | 7.048E−01 | 0.000E+00 | 7.840E−06 |
| H | −5.678E+02 | 0.000E+00 | −2.972E−01 | 0.000E+00 | −8.752E−07 |
| J | 2.986E+02 | 0.000E+00 | 5.324E−02 | 0.000E+00 | 4.100E−08 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

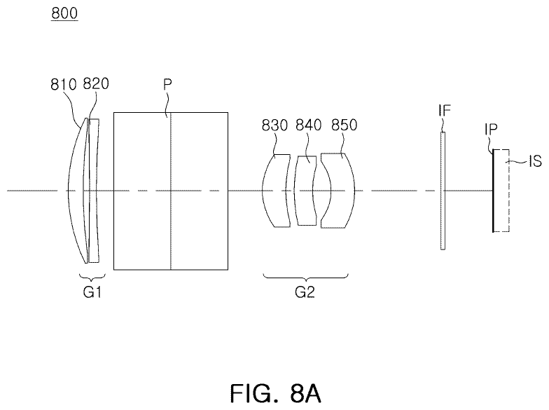

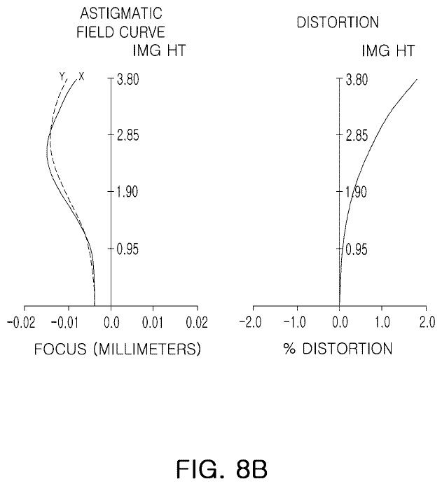

FIG. 8A is a schematic diagram of an optical imaging system according to an eighth embodiment of the present disclosure, and FIG. 8B is a graph illustrating the aberration characteristics of the optical imaging system of FIG. 8A.

An optical imaging system 800 according to the eighth embodiment of the present disclosure may include a first lens group G1, an optical path conversion member P, and a second lens group G2, arranged sequentially from the object side.

The first lens group G1 may include a first lens 810 and a second lens 820, arranged sequentially from the object side. The second lens group G2 may include a third lens 830, a fourth lens 840, and a fifth lens 850, arranged sequentially from the object side.

In addition, the optical imaging system 800 may further include a filter IF and an image sensor IS having an imaging plane IP.

The optical path conversion member P may be disposed between the first lens group G1 and the second lens group G2, for example, between the second lens 820 and the third lens 830. For example, the optical path conversion member P may be configured as a prism including a reflective surface.

The physical and optical characteristics of the optical elements constituting the optical imaging system 800 according to the eighth embodiment of the present disclosure are as shown in Table 15 below.

TABLE 15

| | | | | | | Effective | Effective |
|---|---|---|---|---|---|---|---|
| Surface | | | Thickness/ | Refractive | Abbe | Radius of | Radius of |
| No. | Component | Curvature | Distance | Index | Number | major axis | minor axis |
| Object | | Infinity | Infinity | | | | |
| S1 | | Infinity | 0.000 | | | | |
| S2 | First lens | 7.175 | 0.864 | 1.535 | 55.74 | 4.000 | 4.000 |
| S3 | | 16.537 | 0.337 | | | 3.969 | 3.969 |
| S4 | Second lens | −102.950 | 0.400 | 1.661 | 20.38 | 3.969 | 3.969 |
| S5 | | 60.506 | 1.020 | | | 3.880 | 3.880 |
| S6 | Prism | Infinity | 3.100 | 1.717 | 29.50 | 4.000 | 2.900 |
| S7 | | Infinity | 3.100 | 1.717 | 29.50 | 4.000 | 4.383 |
| S8 | | Infinity | 1.907 | | | 4.000 | 2.900 |
| S9 | Third lens | 3.397 | 1.300 | 1.535 | 55.74 | 2.300 | 2.000 |
| S10 | | 7.283 | 0.495 | | | 2.421 | 2.000 |
| S11 | Fourth lens | 11.242 | 1.000 | 1.614 | 25.94 | 1.874 | 1.874 |
| S12 | (Stop) | 6.379 | 1.000 | | | 1.509 | 1.509 |
| S13 | Fifth lens | −3.106 | 1.300 | 1.650 | 21.54 | 1.631 | 1.631 |
| S14 | | −4.601 | 4.761 | | | 2.000 | 2.000 |
| S15 | Filter | Infinity | 0.210 | 1.517 | 62.00 | | |
| S16 | | Infinity | 2.669 | | | | |
| S17 | Imaging | Infinity | | | | | |
| | plane | | | | | | |

In the eighth embodiment of the present disclosure, the first lens 810 may have positive refractive power, a first surface of the first lens 810 may be convex, and a second surface of the first lens 810 may be concave. The second lens 820 may have negative refractive power, and both a first surface of the second lens 820 and a second surface of the second lens 820 may be concave. The third lens 830 may have positive refractive power, a first surface of the third lens 830 may be convex, and a second surface of the third lens 830 may be concave. The fourth lens 840 may have negative refractive power, a first surface of the fourth lens 840 may be convex, and a second surface of the fourth lens 840 may be concave. The fifth lens 850 may have negative refractive power, a first surface of the fifth lens 850 may be concave, and a second surface of the fifth lens 850 may be convex.

According to the eighth embodiment of the present disclosure, the second lens group G2 may include a D-cut lens. For example, the third lens 830 may be provided as a D-cut lens.

Aspheric data for the individual lenses constituting the optical imaging system 800 according to the eighth embodiment of the present disclosure is shown in Table 16 below. According to the eighth embodiment, the first and second surfaces of the first lens 810 to the fifth lens 850 may all be aspherical.

TABLE 16

| Surface No. | S2 | S3 | S4 | S5 | S9 |
|---|---|---|---|---|---|
| K | −0.9485 | −18.5186 | 99.0000 | 93.8988 | −0.0262 |
| A | −2.218E−04 | −1.137E−04 | 1.218E−04 | −2.262E−05 | 2.298E−04 |
| B | −8.371E−06 | −1.492E−05 | 3.082E−06 | −6.279E−07 | −4.095E−05 |
| C | −7.978E−07 | −4.446E−07 | −1.058E−07 | 9.727E−08 | 1.563E−05 |
| D | −6.923E−09 | −7.936E−09 | −1.897E−08 | −2.126E−08 | −2.482E−07 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Component | S10 | S11 | S12 | S13 | S14 |
| K | 0.0371 | 23.4779 | 0.1517 | 0.5278 | −6.1255 |
| A | 1.135E−01 | 1.940E−03 | 2.522E−02 | −5.463E−03 | −1.788E−01 |
| B | −9.469E−01 | −1.189E−03 | −1.960E−02 | −1.892E−04 | 6.654E−02 |
| C | 1.646E+00 | 2.513E−05 | 1.046E−01 | −4.425E−05 | −7.641E−02 |
| D | −1.094E+01 | 1.465E−07 | −3.686E−01 | 4.019E−06 | 2.505E−01 |
| E | 6.036E+01 | 0.000E+00 | 7.989E−01 | 0.000E+00 | −6.756E−01 |
| F | −2.152E+02 | 0.000E+00 | −1.065E+00 | 0.000E+00 | 1.151E+00 |
| G | 4.728E+02 | 0.000E+00 | 8.553E−01 | 0.000E+00 | −1.159E+00 |
| H | −5.740E+02 | 0.000E+00 | −3.797E−01 | 0.000E+00 | 6.344E−01 |
| J | 2.957E+02 | 0.000E+00 | 7.169E−02 | 0.000E+00 | −1.455E−01 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

Table 17 illustrates other physical and optical parameters, including the focal lengths of individual lenses constituting the optical imaging systems according to the embodiments of the present disclosure. In Table 17, f3 is a focal length of the third lens, f4 is a focal length of the fourth lens, f5 is a focal length of the fifth lens, BFL is a distance on the optical axis from an image side surface of the fifth lens to an image plane, IMH is a maximum effective image height (IMG HT) of the optical imaging system and is equal to one half of a diagonal length of the effective imaging area of the imaging plane of the image sensor. Table 18 illustrates conditional expression data according to the embodiments of the present disclosure.

TABLE 17

| | First | Second | Third | Fourth | Fifth | Sixth | Seventh | Eighth |
|---|---|---|---|---|---|---|---|---|
| | embodi- | embodi- | embodi- | embodi- | embodi- | embodi- | embodi- | embodi- |
| Remark | ment | ment | ment | ment | ment | ment | ment | ment |
| f | 18.008 | 18.007 | 18.008 | 18.008 | 18.008 | 18.008 | 18.009 | 18.009 |
| f1 | 20.000 | 20.238 | 23.432 | 23.867 | 21.642 | 24.408 | 23.657 | 22.956 |
| f2 | −33.833 | −35.635 | −51.732 | −57.591 | −41.724 | −59.991 | −58.289 | −57.618 |
| f3 | 10.858 | 10.627 | 10.873 | 10.984 | 10.736 | 11.094 | 10.859 | 10.662 |
| f4 | −41.135 | −32.236 | −37.673 | −35.139 | −30.323 | −39.436 | −31.355 | −26.040 |
| f5 | −18.798 | −20.189 | −19.431 | −21.298 | −23.484 | −20.249 | −21.000 | −22.367 |
| fG1 | 44.997 | 43.468 | 40.853 | 39.122 | 42.201 | 39.518 | 38.203 | 36.624 |
| fG2 | 27.315 | 28.062 | 29.715 | 29.950 | 27.911 | 30.024 | 31.323 | 32.753 |
| h1 | 8.821 | 8.821 | 8.821 | 8.821 | 8.821 | 8.821 | 8.821 | 8.821 |
| h2 | 4.000 | 4.000 | 4.000 | 4.000 | 4.000 | 4.000 | 4.000 | 4.000 |
| OAL | 24.450 | 24.238 | 23.793 | 24.007 | 24.198 | 23.847 | 23.649 | 23.463 |
| BFL | 7.133 | 7.300 | 7.746 | 7.777 | 7.785 | 7.805 | 7.660 | 7.640 |
| dG1G2 | 10.120 | 9.871 | 9.191 | 9.486 | 9.537 | 9.256 | 9.219 | 9.127 |
| Fno | 3.033 | 3.040 | 3.074 | 3.002 | 3.040 | 3.039 | 3.007 | 2.970 |
| FOV | 22.126 | 22.124 | 22.121 | 22.119 | 22.122 | 22.121 | 22.119 | 22.121 |
| IMH | 3.575 | 3.575 | 3.575 | 3.575 | 3.575 | 3.575 | 3.575 | 3.575 |

TABLE 18

| | First | Second | Third | Fourth | Fifth | Sixth | Seventh | Eighth |
|---|---|---|---|---|---|---|---|---|
| Conditional | embodi- | embodi- | embodi- | embodi- | embodi- | embodi- | embodi- | embodi- |
| Expression | ment | ment | ment | ment | ment | ment | ment | ment |
| \|f/f1\| + \|f/f2\| | 1.433 | 1.395 | 1.117 | 1.067 | 1.264 | 1.038 | 1.070 | 1.097 |
| fG1/f | 2.499 | 2.414 | 2.269 | 2.173 | 2.343 | 2.195 | 2.121 | 2.034 |
| fG1/fG2 | 1.647 | 1.549 | 1.375 | 1.306 | 1.512 | 1.316 | 1.220 | 1.118 |
| h1/h2 | 2.205 | 2.205 | 2.205 | 2.205 | 2.205 | 2.205 | 2.205 | 2.205 |
| dG1G2/OAL | 0.414 | 0.407 | 0.386 | 0.395 | 0.394 | 0.388 | 0.390 | 0.389 |
| h2/Fno | 1.319 | 1.316 | 1.301 | 1.333 | 1.316 | 1.316 | 1.330 | 1.347 |

The optical imaging systems according to the embodiments of the present disclosure may enable high-quality and bright image capturing and further reduce a module height.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, an optical path conversion member, and a second lens group, arranged sequentially from an object side,
wherein the first lens group comprises a plurality of lenses arranged along a first optical axis, and the second lens group comprises a plurality of lenses arranged along a second optical axis, and
wherein the optical imaging system satisfies conditional expression 1.5≤fG1/f≤3.0, where fG1 is a focal length of the first lens group and f is a focal length of the optical imaging system.

2. The optical imaging system of claim 1, wherein the optical imaging system satisfies conditional expression 1.0<fG1/fG2≤2.0, where fG2 is a focal length of the second lens group.

3. The optical imaging system of claim 1, wherein the optical imaging system satisfies conditional expression 2≤h1/h2≤3, where h1 is a maximum height of the optical imaging system in a first optical axis direction and h2 is a maximum height of the second lens group in the first optical axis direction.

4. The optical imaging system of claim 1, wherein the optical imaging system satisfies conditional expression 0.5≤h2/Fno≤2 (unit: mm), where h2 is a maximum height of the second lens group in a first optical axis direction and Fno is an F value of the optical imaging system.

5. The optical imaging system of claim 1, wherein the first lens group comprises a first lens and a second lens arranged sequentially from the object side, and the first lens has positive refractive power and the second lens has negative refractive power.

6. The optical imaging system of claim 5, wherein the optical imaging system satisfies conditional expression 0.5≤|f/f1|+|f/f2|≤2.0, where f1 is a focal length of the first lens and f2 is a focal length of the second lens.

7. The optical imaging system of claim 5, wherein an image-side surface of the first lens and an object-side surface of the second lens are each concave.

8. The optical imaging system of claim 1, wherein the first lens group and the second lens group each have positive refractive power, and a focal length of the second lens group is shorter than a focal length of the first lens group.

9. The optical imaging system of claim 1, wherein the optical imaging system comprises a first lens, a second lens, a third lens, a fourth lens, and a fifth lens arranged sequentially from the object side, and satisfies conditional expression 0.3≤dG1G2/OAL≤0.5, where dG1G2 is a distance on an optical axis between the first lens group and the second lens group, OAL is a distance on the optical axis from an object-side surface of the first lens to an image plane, and the optical axis includes the first optical axis and the second optical axis.

10. The optical imaging system of claim 9, wherein the first lens has positive refractive power, the second lens has negative refractive power, the third lens has positive refractive power, the fourth lens has negative refractive power, and the fifth lens has negative refractive power.

11. The optical imaging system of claim 10, wherein the first lens group comprises the first lens and the second lens, and the second lens group comprises the third lens, the fourth lens, and the fifth lens.

12. The optical imaging system of claim 10, wherein an object-side surface of the third lens is convex, and an image-side surface of the third lens is concave.

13. The optical imaging system of claim 10, wherein an object-side surface of the fourth lens is convex.

14. The optical imaging system of claim 10, wherein an object-side surface of the fifth lens is concave.

15. The optical imaging system of claim 10, wherein an image-side surface of the fifth lens is convex.

16. The optical imaging system of claim 10, wherein the third lens is a D-cut lens.
